(19) United States
(12) Patent Application Publication
(10) Pub. No.: US 2011/0071894 A1
(43) Pub. Date: Mar. 24, 2011

(54) METHOD AND SYSTEM FOR SERVING LOCALIZED ADVERTISEMENTS

(76) Inventors: Diaz NESAMONEY, Atherton, CA (US); Parth S. CHANDRA, Palo Alto, CA (US)

(21) Appl. No.: 12/562,994

(22) Filed: Sep. 18, 2009

(51) Int. Cl. G06Q 30/00

(52) U.S. Cl. 705/14.25; 705/14.58; 705/14.66; 705/14.52

(57) ABSTRACT

Users create advertisement components using a browser-based application. Once the components are generated, the application compiles the components on the backend to generate a seamless advertisement. Metadata are applied to the advertisements to specify a geographic location, demographics, and keywords. The advertisements are matched up with clients based on identifying information in the user profiles. The geographic location includes zip codes and surrounding areas. The advertisement includes coupons that are presented in local stores. The cost of displaying the advertisement is negotiated between the advertiser and the publisher according to the number of slots available, and the prices that each party is willing to accept.

### BACKGROUND OF THE INVENTION

1. Technical Field

This invention relates generally to the field of targeted advertisements. More specifically, this invention relates to serving local advertisements to increase interest.

2. Description of the Related Art

The field of advertising is changing drastically as a result of advancements in technology, such as the popularity of mobile devices, and the death of print media. As a result, advertisements now appear on websites, in video clips, in emails, etc.

Instead of sending the same advertisement to everyone, there is a trend towards using targeted advertisements. Google, for example, uses targeted advertisements in its search engine results that are a function of search terms and the user's Internet history. Google also suggests search terms for users based on the user's Internet history and the user's location. In US 2006/0230350, for example, Google describes an Internet enabled mobile device that provides suggested search terms based on a user's location. The mobile device uses a global positioning system to identify the user's location and provides search terms based on what other people in the surrounding area used as search terms.

The position of advertisements on a webpage displaying search results is a function of how much the advertisers are willing to pay for the ad space. As a result, large companies almost always occupy the highest positions. This is a problem when a user wants to obtain local results from a search engine. For example, when “pizza in Palo Alto” is typed into Google's search engine, the sponsored link is from Dominos. Dominos' pizza is not acceptable for a person looking for a place to eat in Palo Alto.

The results returned with Yahoo's search engine are even worse. When “pizza in Palo Alto” is typed into Yahoo's search engine, the first result is from North Beach Pizza, which is not even located in Palo Alto. The closest location for North Beach Pizza is in San Mateo, which is 11 miles away from Palo Alto. Anyone simply trying to grab a slice of pizza in Palo Alto before watching a movie, for example, is not willing to travel 11 miles for pizza when Palo Alto itself has several good pizza restaurants.

### SUMMARY OF THE INVENTION

In one embodiment, the invention is a system and method for allowing users to create advertisements and target customers in local markets. A software application allows a advertiser to assemble different components for advertisements using a browser-based application. Once the components are generated, the application compiles the components on the backend to generate a seamless advertisement. The advertisements are played with an ad player. The ad player is either embedded directly in a browser or used as a separate application on a client device. The user's reactions to ads and other media are transmitted to an application server, which analyzes the data, and generates a report and recommendations based on the user behavior. The report is transmitted to the advertiser. The advertiser modifies the advertisement using the report to improve the user's reactions of the advertisement.

In one embodiment, the advertisements are displayed by a computer or a mobile device, such as a smartphone. The advertisements are targeted for a user in a geographic area, e.g. town, zip code, neighborhood and advertisements are served to the user for local products. If the user has a mobile device, the user's location can be determined using, for example, a global positioning system to locate the nearest stores.

In one embodiment, the advertisement is a coupon for a local store. Because the user is in close proximity to the store, the user is more incentivized to visit the store. The user presents the coupon at the store, e.g. a restaurant, to receive the discount. In other embodiment, the advertisement is a banner, overlay, or video.

The advertisement selected for display is determined according to prioritization and pacing. Prioritization is a function of competing criteria, including localization priority, urgency, relevancy, and price. The localization priority gives an increasing preference to localized ads. Urgency is a function of both the budget and the ending time for the ad campaign. The price is a function of whether there is a surplus or dearth of ads for the intended ad slot. In one embodiment, these factors are each assigned weights so that certain factors are more influential in determining an ad for the ad slot. Pacing of an ad campaign controls the number of ads served during a particular time period to prevent the ad campaign from exhausting the budget in a short time.

### BRIEF DESCRIPTION OF THE DRAWINGS

FIG. 1 is a block diagram that illustrates a system for generating advertisements according to one embodiment of the invention;

FIG. 2 is a block diagram that illustrates a system for tracking metadata from clients and selecting customized advertisements for display on the client according to one embodiment of the invention;

FIG. 3 illustrates a user interface for specifying geography according to one embodiment of the invention;

FIG. 4 illustrates a client device that communicates with a server over a network according to one embodiment of the invention;

FIG. 5 is a block diagram that illustrates a system for providing page content and advertisements over a network according to one embodiment of the invention;

FIG. 6 is a flow chart that illustrates steps for generating an advertisement and tracking users' responses according to one embodiment of the invention;

FIG. 7A is a flow chart for setting variables in anticipation of price negotiation between the publisher and the advertiser for placement of the ad according to one embodiment of the invention; and

FIG. 7B is a flow chart of the negotiation process according to one embodiment of the invention.

### DETAILED DESCRIPTION OF THE INVENTION

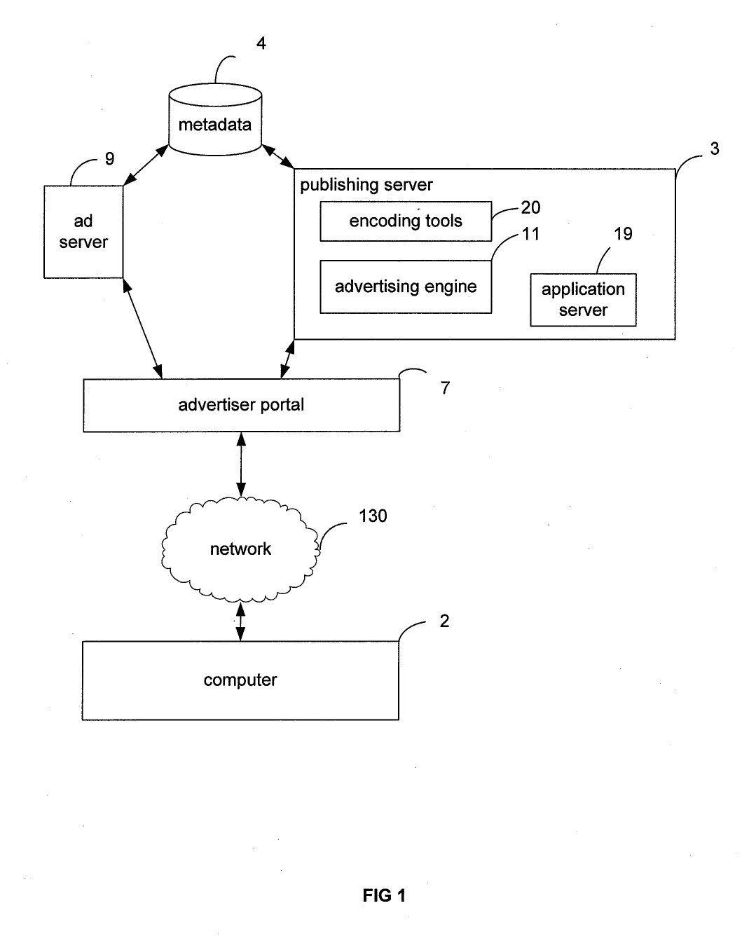

In one embodiment, the invention comprises a method and/or an apparatus for generating advertisements. FIG. 1 is a block diagram that illustrates the system for generating advertisements according to one embodiment of the invention. The apparatus has four main components: an advertiser portal 7 for displaying a user interface for a publisher to create ads; a publishing server 3 for generating ads and pairing the ads with metadata; a metadata database 4 for storing the metadata; and an ad server 9 for storing the ads and transmitting the ads to the ad player or a client device.

Advertiser Portal

The advertiser portal 7 is a browser-based application that is transmitted across a network 130 to a computer 2 for generating advertisements. The network 130 can be a wired network such as a local area network (LAN), a wide area network (WAN), a home network, etc., or a wireless local area network (WLAN), e.g. Wifi, or wireless wide area network (WWAN), e.g. 2G, 3G, 4G. Different components may communicate using one type of network 130, e.g. the ad server 9 and the publishing server 3 communicate using a LAN, while other components communicate using a different type of network.

Because the advertiser portal 7 provides full functionality, the publisher does not waste precious resources such as time and computer power by downloading software for storage on the user's personal computer 2. Instead, the remote servers perform the processing steps required for generating advertisements.

Publishing Server

In one embodiment of the invention, the publishing server 3 comprises an advertising engine 11, an application server 19, and encoding tools 20. The individual components are discussed in more detail below.

The advertisements are either video ads or static ads. Video ads are professionally produced ads that are uploaded to the application server 19 as video clips. Static ads comprise static images, text that is superimposed on the images, and an audio clip that plays while the image is displayed.

In one embodiment, the user generates metadata about the ad to further target audiences. Metadata includes, for example, user demographics, times for distributing the ad, and specific targets for the ad. The encoding tools 20 generate the metadata and associate the metadata with the ad files. The time period for distributing the ad includes a complete schedule of days, a range of dates, particular days of the week, specific dates, an expiration ad date, and a time interval in the day for playing the ad. In one embodiment, these times can be set as preferred times, which means that they are not guaranteed. The times for distributing the ad also takes into account whether the user specified a number of times to play the ad or whether the ad is selected to play until the ad budget is exhausted. Specific targets include a particular movie, etc. or special interests, e.g. travel, outdoor activities, food, wine, etc.

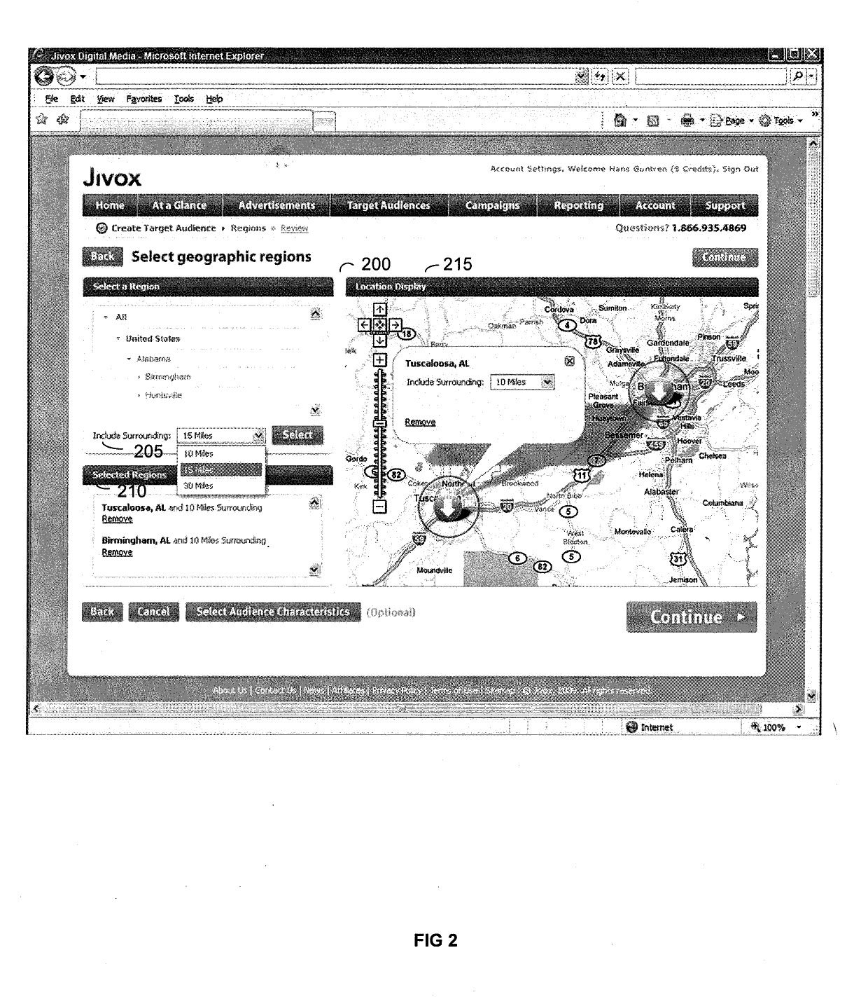

One type of metadata is geographic location for mobile device users. In one embodiment, the user creates an ad campaign by specifying a geographic region for distributing the ad. For example, the user enters a postal code, clicks locations on an interactive map, or selects towns from a list. FIG. 2 illustrates one example of a user interface for specifying geography according to one embodiment of the invention. In this example, the user selects a region with the select a region module 200, specifically, towns in Alabama, and surrounding areas 205 within a specified radius of the towns, e.g. 5, 15, and 30 miles. The selected regions are displayed in the selected regions module 210. The selected towns and regions are displayed on the location display 215 to give the user a visual perspective on the different advertising regions.

The application server 19 is the back end support for a variety of processes. For example, the application server 19 stores advertiser billing information and, in one embodiment, comprises a billing module to generate monthly billing statements. In addition, the application server 19 saves and transcodes ads to formats selected by the user or selected automatically. To ensure compatibility with media players 10 and browsers 16, the application server 19 transcodes the ads to all compatible formats. In one embodiment, video ads are transcoded to an MP4 container, using H.264 video encoding and AAC audio encoding.

The application server 19 accepts ad metadata, such as user profile information that is associated with a website's visitors or registered users or from a media player 10 and publishes it with the ad files 12 in a metadata database 4 through the use of encoding tools 20. The ad server 9 also accesses the metadata database 4 to download the ad files 12 and the ad metadata. Before the ad is sent to the metadata database 4, an advertising administrator reviews the user-created ad to ensure that it complies with copyright law, does not contain pornographic material, etc.

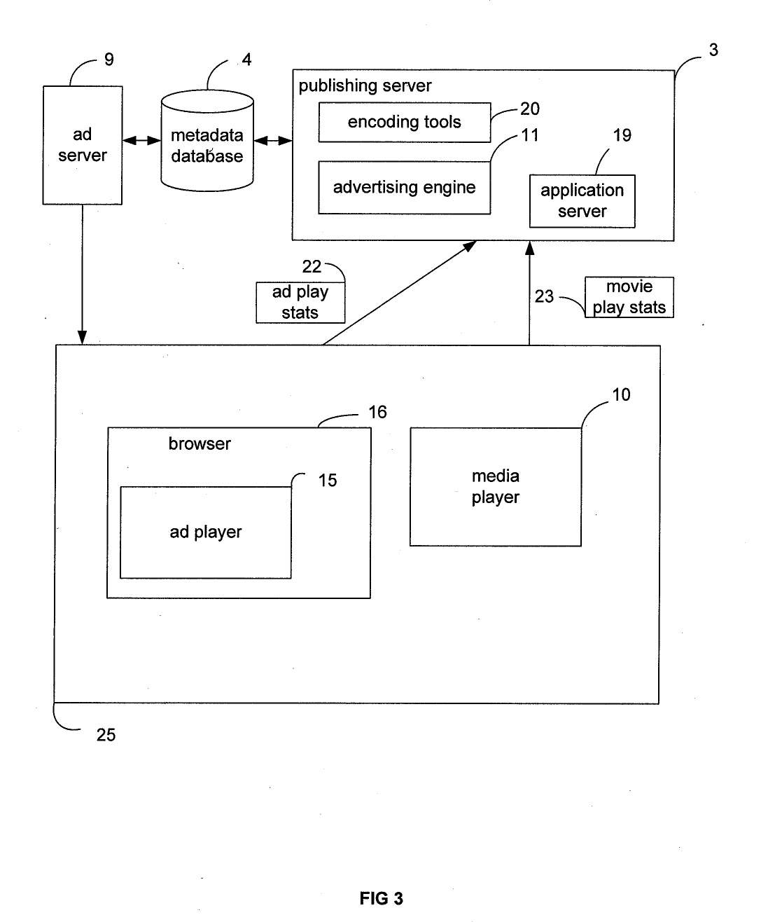

The advertising engine 11 manages the targeting of ads to particular profiles. FIG. 3 illustrates the transmission of metadata from the client 25 to the publishing server 3 according to one embodiment of the invention. Based on the data available for the user profiles and other metadata, the advertising engine 11 determines a set of heuristics to pick the most appropriate ads to be pushed to the ad player. For every media device 25, the advertising engine 11 creates an ad list of names for ad files for display on the client 25. The specifics for generating the ad list are described in further detail below. The advertising engine 11 tags every ad name with constraint metatdata that restricts the scheduling of the ad to particular times. The ad list is periodically updated to remove names for user profiles that have been deleted, incorporate edits to user profiles, include new advertisements, incorporate new users, etc.

In one embodiment, the advertising engine 11 matches ad files with an appropriate movie. For example, an ad is tagged with ad metadata for hiking. The movies have metadata describing chapter boundaries, chapter names, movie keywords, genre, and typical data that a person of ordinary skill in the art would expect to find associated with a movie, e.g. director name, producer name, actor names, etc. If the metadata for a movie specifies that it is related to nature, it should be paired with the ad relating to hiking.

In one embodiment, the publishing server 3 receives movie play statistics 23 from the client and ad play statistics 22 from the ad player 15 and/or the media player 10. The movie play statistics 23 include the identity of the movie, the time it was played, etc. The ad play statistics 22 include the identity of the ad played, the time at which it was played, the movie with which it was associated, and the user's reaction to the ad. The user's reaction reflects the user's interest in an advertisement, e.g. whether the user clicked on the ad to be directed to the advertiser's website, whether the user purchased a product from the advertiser's website, whether the user forwarded the advertisement to a friend, etc.

The application server 19 aggregates the ad play statistics 22 and the movie play statistics 23, analyzes the information, and generates reports for providing recommendations to improve user responses to the advertisements. The reports include an ad inventory and the times during which the ads were played. The reports are downloadable in a format that is easy to load into an existing analytics system, e.g. Microsoft excel.

Ad Server

The ad server 9 is a streaming server that uploads ad files in response to a request for an ad file. In one embodiment, the ad player 15 is embedded in a browser 16 that is displayed on the client 25. When the ad player 15 is called from a particular website, it send the site id and user name to the ad server 9. The ad server 9 looks up the user profile information in the metadata database 4 and finds matching ads. The ad server 9 transmits the ads for display on the ad player 15.

Client

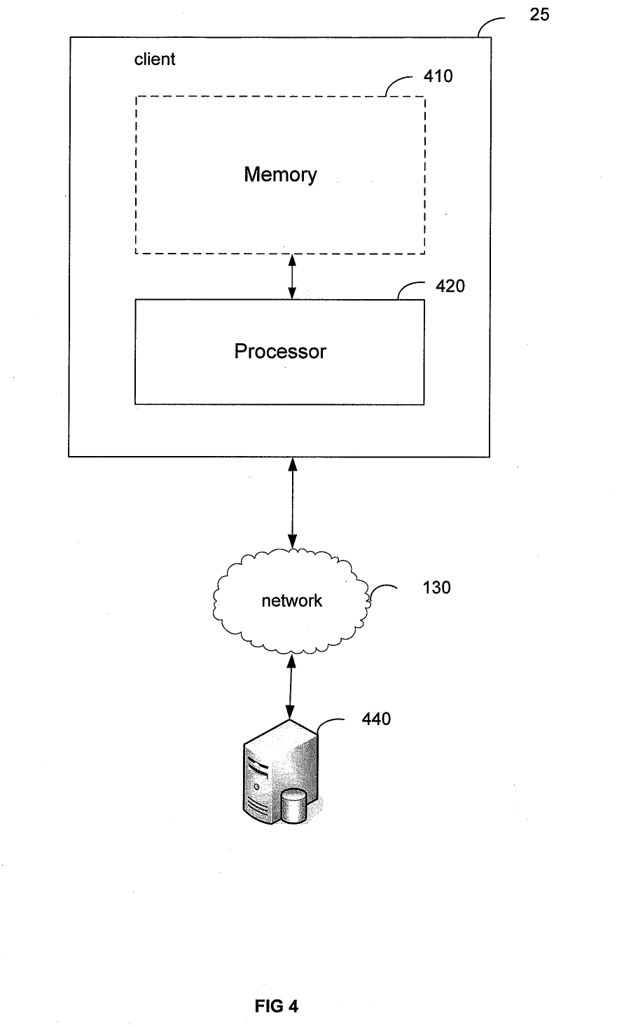

The client 25 comprises a computing platform configured to act as a client device, e.g. a computer, a digital media player, a personal digital assistant, etc. In one embodiment, the client 25 is a mobile device, which is any type of client that is small enough to be portable, e.g. digital assistant, personal digital assistant, cellular phones, mobile phones, smart phones, digital tables, laptop computers, AmazonKindle®, etc. FIG. 4 is an example of a client 25 for receiving advertisements according to one embodiment of the invention. The client 25 comprises a processor 420 that is coupled to a number of external or internal inputting devices, e.g. a touchpad, a keyboard, a display device, etc. The processor 420 is coupled to a communication device that is configured to communicate via a communication network, i.e. the Internet.

The client 25 includes a computer-readable storage medium, i.e. memory 425. The memory 425 includes, but is not limited to, an electronic, optical, magnetic, or another storage or transmission device capable of coupling to a processor 420, such as a processor 420 in communication with a touch-sensitive input device, with computer-readable instructions. Specific examples of suitable media include flash drive, CD-ROM, read only memory (ROM), random access memory (RAM), application-specific integrated circuit (ASIC), DVD, magnetic disk, memory chip, etc.

The processor 420 executes a set of computer-executable program code instructions stored in the memory 425. The instructions may comprise code from any computer-programming language, including, for example, C, C++, C# or Visual Basic, or source code in any interpreted language such as Java or JavaScript.

In one embodiment, a user profile is generated for each client 25 or for each registered user. The user profiles include a client identification, a household identification, a profile name, a user profile identification, and a household user name. The user profile can be edited, deleted, or renamed. The timestamp of the last change made to a profile is crucial to the targeting of ads so it needs to be recorded correctly. The user profiles are transmitted to the application server 19 at the time of creation and after any modifications are made.

The media player 10 manages the playing of ads during a movie. The media player 10 includes a buffer for temporary storage of streaming content. When the media player 10 starts a movie, the media player 10 obtains metadata about the chapter breaks for the movie from the move metadata file and accesses metadata files 13 for the ads. The media player 10 initializes a list of available ads. The media player 10 picks the first available ad that satisfies the constraints specified by the metadata. For example, ads that are specific to the movie, check whether the ad can be played during that time period, whether the ads are appropriate given the user profile, etc. Based on these constraints and the current download speed, the media player 10 determines when an ad is played and how many ads are played during an advertising break.

The ad player 15 and the media player 10 track the ads and generate ad playing statistics 22. In addition, the media player 10 generates movie play statistics 23. The files are transmitted to the application server 19.

Browser Example

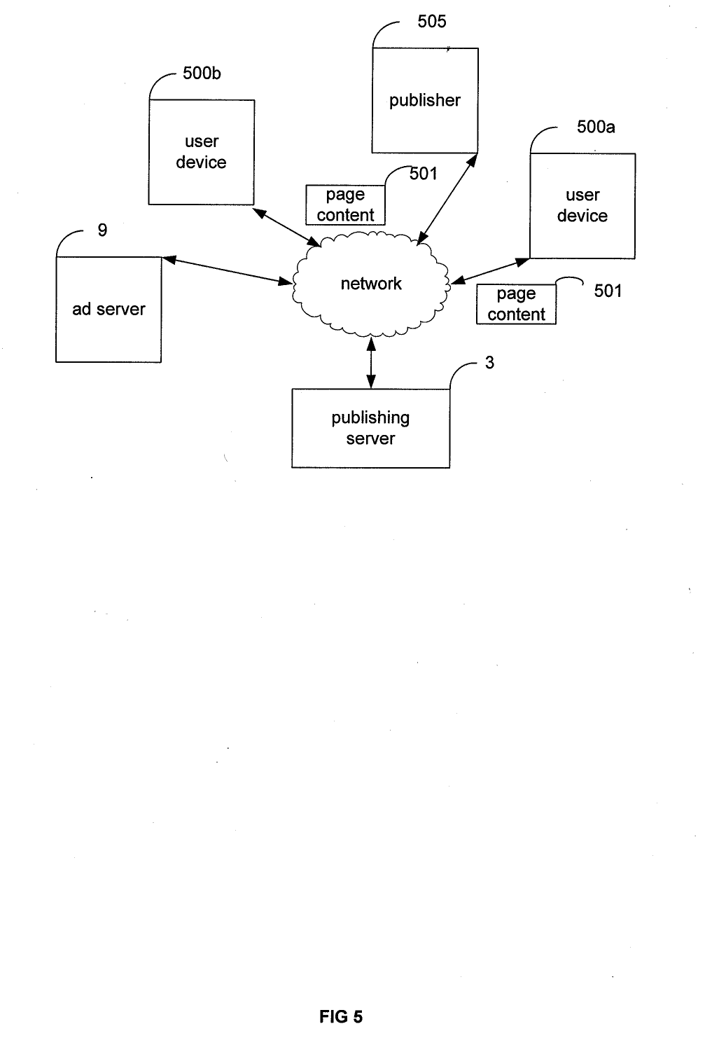

FIG. 5 is a block diagram of an environment for serving advertisements to a user device. In this example, the user device 500 is a client. The client can be a mobile device as described in detail in the previous example or a personal computer.

When a user device 500 requests page content 501 from a publisher 505, the advertisement is either served along with the page content 501 or served separately. If the publisher 505 serves the ads along with the page content 501, the publisher 505 obtains the ads from the ad server 9. In this model, the publisher 505 either queries the ad server 9 for the ads after the user device 500a requests the page content 501 or the publisher 505 has a separate repository of ads. Alternatively, the publishing server 3 provides the publisher 505 with executable instructions, e.g. HTML code or JavaScript instructions that are executed at the user device 500a to retrieve the advertisements from the ad server 9. The serving of ads along with page content 501 is a dynamic process to ensure that user devices 500a and 500b receive the same page content 501 but different ads.

Determining the User's Location

The ad server 9 determines the user's location in any of a variety of different ways. For example, the user location can be extracted from a user profile. Alternatively, the user may have entered a location into a search engine, e.g. a zip code, city, etc. The ad server 9 may also be able to map the user's location from the internet protocol (IP) address for the client 25 to determine the user's regional location. In one embodiment, the user's IP address is included in the user profile, which the ad server 9 receives from the ad publishing module 3. In another embodiment, the client 25 is a mobile device and the user's location is identified using a global positioning system (GPS). The ad server 9 filters out ads where the metadata does not include the user's regional location. The ad player displays the filtered ad or ads.

The browser 16 tracks the user's response to the ads. For example, the user may perform a click-through by clicking on the ad to visit the advertiser's website. The user performs a conversion by performing additional actions at the advertiser's website, such as requesting information from the advertiser, making a purchase, registering with the advertiser, etc. In one embodiment, the ad can be downloaded, emailed, embedded on a website, e.g. a blog, transmitted via short message service (SMS), etc. The ad player 15 tracks all this information and transmits the ad play statistics 22 to the application server 19 for analysis.

In one embodiment, the ad is a coupon for a local business. The user is much more likely to use the coupon because of the convenience. GPS, furthermore, is so accurate that the application server 19 can determine that a user near or is approaching a specific store, e.g. a coffee shop and serve a coupon for the coffee shop before the user arrives. The user is even more likely to use a coupon for a store when it does not change the user's plans, for example, by advertising a store all the way across town or in a different city altogether.

Billing

The application server 19 is responsible for billing. Advertisers can choose from many different pricing structures while placing an ad. The common methods are cost per mille (CPM), cost per click (CPC), and cost per lead (CPL). For CPM, the advertiser pays every time an advertisement is displayed. In CPC, the advertiser pays only after a user clicks on an advertisement. In CPL, the advertiser pays only if the click results in a lead (or some transaction) at the advertiser's website.

Even though these are different pricing structures, advertisements with different pricing are compared by normalizing the ads to an equivalent price. In general, the normalization is done by calculating the expected revenue from a particular advertisement. The expected revenue is the price multiplied by the probability of occurrence of the event upon which the price will be paid. CPM advertisements have a probability of one. CPC advertisements have a probability defined as the click-through rate. CPL advertisements have a probability defined by the lead conversion rate, which is determined based on data from cooperating advertisers.

Conversion probabilities are determined according to the data available. If little or no data is available, an industry standard value is used. For click-through rates, the data is collected every time an advertisement is clicked. In one embodiment, the probabilities is calculated based on data across all publishers or on a per publisher site.

The ad server 9 receives ads from a plurality of advertisers. Frequently, there are more ads available for publication on a website than space available, even when the ads are targeted for users. As a result, the ads are prioritized. Factors for prioritizing ads include the level of localization of the ad, the timing of the ad campaign (urgency measure), and the ad pricing, which is a dynamic price negotiation method.

Selecting an Ad

Ads are selected based on prioritization and pacing. Prioritization is a function of localization priority, urgency, relevancy, and price. Pacing determines the maximum number of ads that are served in a day to prevent the ad campaign budget from being exhausted in a short time. In one embodiment of the invention, the different factors are weighted. For example, the localization priority may be twice as important as the urgency.

Localization Priority

The more localized the ad, the higher the localization priority. For example, town>zip code>state>country. As a result, an ad that is merely targeted for the United States has a much lower priority than an ad that specifies a specific zip code.

Urgency Measure

The urgency measure is dynamically determined according to both the budget remaining and the ending time for the ad campaign. The closer the end date and the greater the budget, the higher the urgency. The urgency measure is expressed as the rate at which the budget must be spent to achieve maximum use of the budget. The urgency measure is not equivalent to a ranking because, where a ranking would place the priority of one ad over another, the urgency measure also expresses how many more times the ad must be played as compared to another ad.

Dynamic Price Negotiation

The basic principle of dynamic advertisement price negotiation is that the system has to be equally fair to both publishers and advertisers. The system cannot be biased in favor of one or the other. This is achieved by determining whether, in a given video session, the negotiation is operating in a buyer's market or a seller's market. If there are more slots than there are ads available, it is a buyer's market and the seller must lower the asking price. If there are more slots than ads available, the buyer raises the price he is willing to pay. The publisher specifies a starting price for the bidding to begin.

Dynamic price negotiation allows advertisers and publishers to get the best possible price for their advertisement or their slot inventory. The purpose of the negotiation is to a simulate real world marketplace where publishers demand a price for placing an advertisement on their website and advertisers try to place advertisements on sites for the lowest possible cost and the highest reach.

Dynamic price negotiation occurs when either the publisher has a surplus inventory of ad slots or there are more advertisements that qualify for an ad slot than there are ad slots available. In the first case, the system dynamically drops the minimum price required by the publisher until a sufficient number of ads are available to fill all the slots. The publisher specifies a hard limit, i.e. a reserve price, below which the price cannot drop even if it means some ad slots remain open. When there are more advertisements than slots available, the system dynamically increases the price up to a maximum limit. The top bidder gets an advertisement played.

In one embodiment, each advertisement is downloaded separately, i.e. on demand and the negotiation occurs at that time. In another embodiment, ads are downloaded in groups and the negotiation occurs for each group.

Reporting

The dynamic price negotiation system includes reporting the effectiveness of the chosen pricing model to publishers and advertisers. The report includes the average price bid every time the advertisement is played, the click-through rate, and the conversion rate if available. Based on the effectiveness of the ads, the advertiser increases or decreases the bid price to get bids that are commensurate with the value of the advertisement. For publishers, the report includes how much ad inventory went unused or how many times the system dropped the price below the asking price.

Pacing

Pacing of a campaign essentially smoothes out the number of ads that are served each day so that a campaign is served evenly through its duration. If, on a given day, there is a sudden spike in calls to the ad server 9, the campaign's budget can be exhausted in one day. Pacing prevents spikes by limiting the number of impressions that are served in a given day. The number of impressions that are served is a variable number that is updated dynamically by dividing the number of impressions that remain to be served by the time remaining. The number of ads to be served on any given day in the campaign can be recomputed at any desired frequency. This could include every minute, although once a day is more practical. In one embodiment, the pacing algorithm can be manually overridden for more specific control.

The selection of an ad involves a tension between the pacing algorithm and prioritization algorithms. Pacing typically slows down an ad campaign, which in turn increases the urgency. The increase in urgency increases priority, which causes an ad to be selected more frequently. Increasing the priority causes the pacing to try and slow down the campaign. This tension continues until an equilibrium is reached.

Flow Chart for Serving Advertisements

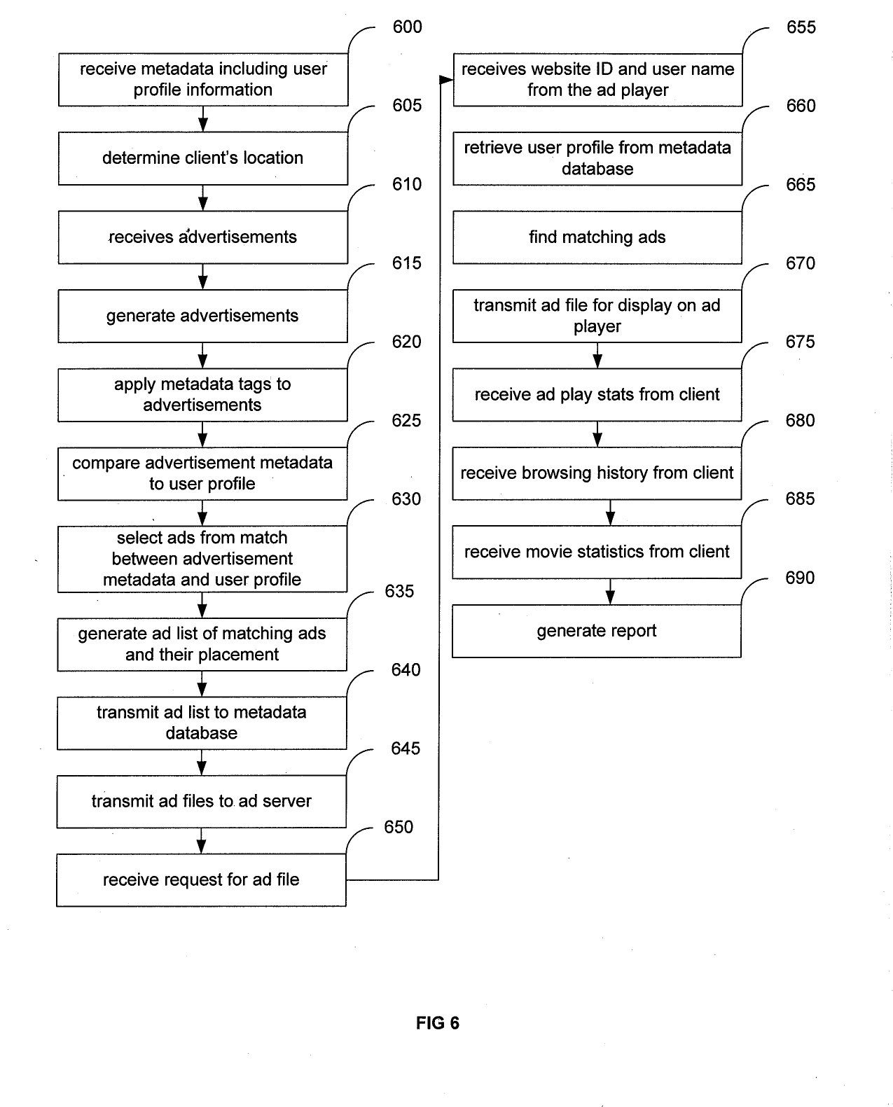

FIG. 6 is a flow chart that illustrates steps for serving a localized advertisement to a user according to one embodiment of the invention. The application server 19 receives 600 metadata, including user profile information. The application server determines 605 the client's location from any of the user profile, a location entered as a search term in a search engine, from a GPS enabled device, or from an IP address that can be mapped to a geographic location. The publishing server 3 receives 610 advertisements according to one embodiment of the invention. In another embodiment, or in addition, the advertising publishing module 3 generates advertisements 615.

The advertising engine 11 applies 620 metadata tags to the advertisements. The advertising engine 11 compares 625 the advertisement metadata to the user profile 24. The advertising engine 11 selects 630 ads from a match between advertisement metadata and the user profile 24. The match is based on relevancy, i.e. geographic location, the demographics of the end user, and keywords describing the content and urgency, i.e. the budget and remaining time in the ad campaign. The advertising engine 11 generates 635 an ad list that specifies the matching ads and their placement. The placement is determined from prioritization, including relevancy and urgency measures and price negotiation and from pacing. The advertising engine 11 transmits 640 the ad list to the metadata database 4. The application server 19 transmits 645 the ad files 12 to the ad server 9.

The ad server 9 receives 650 a request for an ad file. The ad server 9 receives 655 a website ID and user name from the ad player 15. The ad server 9 retrieves 660 the user profile information from the metadata database 4 and finds 665 matching ads. The ad server 9 transmits 670 the ad file for display on the ad player 15. The user watches the ad on the client 25. Once the ad has been viewed, the client transmits and the application server 19 receives 675 ad play stats 22 from the client 25. The application server 19 receives 680 a browsing history from the client 25. The application server 19 may also receive 685 movie statistics 23 from the client 25. The ad play statistics 22, browsing history, and movie statistics 23 are used by the application server 19 to generate 690 a report.

Flow Chart for Pricing Ads

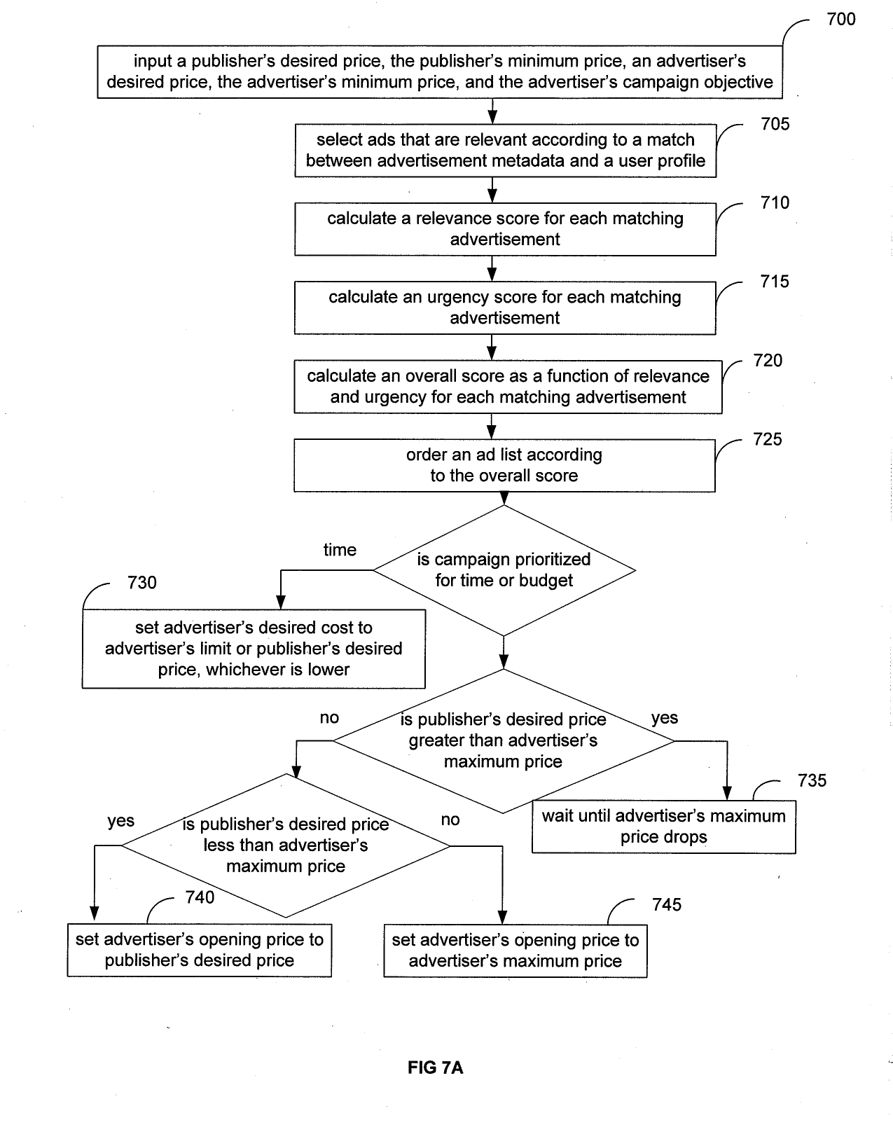

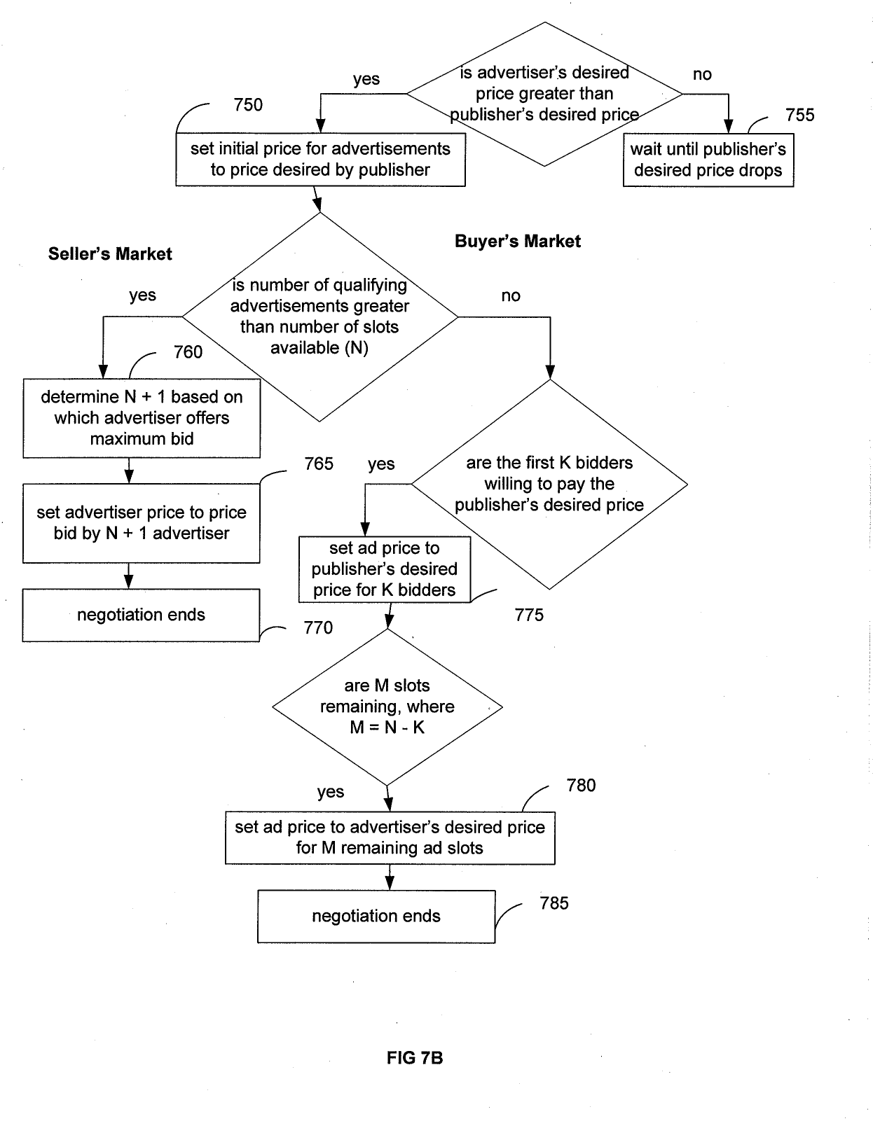

FIG. 7A is a flow chart for setting variables in anticipation of price negotiation between the publisher and the advertiser for placement of the ad according to one embodiment of the invention. The following parameters are input 700 into the price algorithm: a publisher's desired price, a publisher's minimum price, the advertiser's desired price, the advertiser's minimum price, and the advertiser's campaign objective, i.e. whether the advertiser wants the campaign objective optimized for budget or time. The advertising engine 11 selects 705 ads that are relevant according to a match between the advertisement metadata and the user profile.

The advertising engine 11 sorts ads according to relevance by first calculating 710 a relevance score for each matching advertisement. In one embodiment, relevance is a relative score based on the number of matching metadata tags. For example, based on a user profile 24, the potential matches are for five factors: male; Pescadero, Calif.; birds; horror; and surfing. The total score is 25, where each matching factor is worth five points. Thus, the ads will have a relevancy score of 0, 5, 10, 15, 20, or 25. The equation is therefore:

Relevance=#matching metadata factors*#points (Eq. 1)

The advertising engine 11 calculates 715 an urgency score for each advertisement.

Urgency=Budget/Days remaining in campaign (Eq. 2)

The advertising engine 11 calculates 720 an overall score as a function of relevance and urgency according to the following equation:

Score=relevance*K+urgency (Eq. 3)

Where K is a normalization factor that modifies relevancy as compared to urgency. The ad list 21 of advertisements is ordered 725 according to the overall score.

The advertising engine 11 determines whether the campaign objective was optimized for time or budget. If the advertiser set the campaign objective to optimize for time, the advertiser's desired cost is set 730 to either the advertiser's limit or the publisher's desired price, whichever is lower. If the publisher's desired price is greater than the advertiser's maximum, the advertising engine 11 waits 735 until the advertiser's maximum price drops. If the publisher's desired price is less than the advertiser's maximum, the advertiser's opening price is set 740 to the publisher's desired price and the negotiation begins. If the publisher's desired price is greater than the advertiser's maximum, the advertiser's opening price is set 745 to the advertiser's maximum price.

FIG. 7B is a flow chart of the negotiation process according to one embodiment of the invention. Negotiation starts in all instances where the advertiser's desired price is greater than the publisher's desired price. If the advertiser's desired price is less than the publisher's desired price, the advertising engine 11 waits 745 until the publisher's desired price drops.

If the advertiser's desired price is greater than the publisher's desired price, the advertising engine 11 sets 750 the initial price for all advertisements to the price desired by the publisher. If the advertiser's desired price is less than the publisher's desired price, the advertising engine waits 755 until the publisher's desired price drops.

If the number of qualifying advertisements is greater than the number of slots available, the calculations are made according to a seller's market. Specifically, the advertising engine 11 determines 760 N+1 highest bidder based on the advertiser's maximum bid. The first N bidders win. The advertising engine 11 sets 765 the advertiser price to the price bid by the N+1 advertiser. The negotiation ends 770.

If the number of qualifying advertisements is less than the number of slots available, the calculations are made according to a buyer's market. Specifically, if the first K bidders are willing to pay the publisher's desired price, the advertising engine 11 sets 775 the ad price to the publisher's desired price. For the remaining M slots, the M highest bidders are determined according to the following equation:

M=N−K (Eq. 4)

Where M is the number of slots selected, N is the number of slots available, K is the number of bidders that are willing to pay the publisher's desired price. The advertising engine 11 sets the ad price for the remaining slots is set 780 to the desired price for the advertiser picked for each slot. The negotiation ends 785.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

1. A computer-implemented method for selecting advertisements for an ad player, the method comprising:
receiving a request, with an ad server, a request for an ad;
receiving from an ad player a website identification;
retrieving, with the ad server, a user profile based on the website identification;
determining, with the ad server, the user's location;
matching, with the ad server, the user profile to a plurality of ads based on the metadata and the user's location;
determining, with the ad server, an urgency measure comprising an ad budget divided by a time remaining in an ad campaign for each matching ad;
determining, with the ad server, a price for each matching ad as a function of a buyer's bid, a publisher's bid, and the number of ads that are available for a particular slot;
determining, with the ad server, a pace for each matching ad as a function of the number of ads remaining in the ad campaign divided by the time remaining for each ad;
selecting, with the ad server, an ad from the plurality of ads based on the urgency measure, the price, the and the pace; and
transmitting, with the ad server, the selected ad to the ad player.

2. The method of claim 1, wherein the client's location is determined from any of: a user profile, a location entered as a search term, a global positioning system, and an Internet protocol address.

3. The method of claim 1, further comprising the steps of:
updating the user profile with the client's location before the ad server transmits ads to the ad player.

4. The method of claim 1, wherein the metadata tag for geographic location comprises a postal code and a surrounding radius.

5. The method of claim 1, wherein the metadata comprises any of the demographics of the user and keywords describing the content.

6. The method of claim 1, further comprising the step of:
generating, with the ad server, an ad list that is associated with a user profile, the ad list comprising a list of ads where the metadata matches the user profile.

7. A computer implemented method for negotiating an advertising price between a publisher and an advertiser for display on a client, the method comprising:
providing a computer comprising a processor and a memory, the processor configured to implement instructions stored in the memory, the processor performing the following steps:
inputting all of a publisher's desired price, the publisher's minimum price, an advertiser's desired price, the advertiser's minimum price, and the advertiser's campaign objective;
selecting a plurality of ads that are relevant according to a match between ad metadata and a user profile for the client;
calculating a relevance score for each matching advertisement;
calculating an urgency score for each matching advertisement;
calculating an overall score as a function of the relevance score and the urgency score for each matching advertisement;
ordering an ad list according to the overall score;
setting an advertiser's desired cost to the advertiser's limit or the publisher's desired price, whichever is lower;
determining if the publisher's desired price is greater than the advertiser's maximum price;
if the publisher's desired price being greater than the advertiser's maximum price, determining whether the publisher's desired price is less than the advertiser's maximum price;
if the publisher's desired price being less than the advertiser's maximum price, setting the advertiser's opening price to the publisher's desired price;
determining whether the advertiser's desired price is greater than the publisher's desired price;
if the advertiser's desired price being greater than the publisher's desired price, setting the initial price for advertisements to the price desired by the publisher;
determining whether the number of qualifying advertisements are greater than the number of slots available (N);
if the number of qualifying advertisements are greater than the number of slots available, determining the N+1 based on which advertiser offers a maximum bid; and
setting the advertiser price to the price bid by the N+1 advertiser.

8. The method of claim 7, further comprising the step of:
responsive to a publisher's desired price being greater than the advertiser's maximum price, waiting until the advertiser's maximum price drops below the publisher's desired price.

9. The method of claim 7, further comprising the steps of:
if the number of qualifying advertisements are less than the number of slots available (N), determine the number of bidders (K) that are willing to pay the publisher's desired price;
setting an ad price to the publisher's desired price for K;
determining the number of remaining slots (M), where M=N−K; and
setting an ad price to the advertiser's desired price for M.

10. The method of claim 7, further comprising the step of:
if the advertiser's desired price is greater than the publisher's desire price, waiting until the publisher's desired price drops.

11. A system for generating localized advertisements comprising:
a publishing server for generating advertisements, the advertising module comprising:
an application server for storing billing information, publishing an advertisement in conjunction with metadata, receiving ad play statistics and any of movie play statistics and browsing histories for each client, and generating a report analyzing the ad play statistics and any of the movie play statistics and the browsing histories for each client; and
an advertising engine for generating metadata and applying it to each advertisement, the metadata comprising a geographic location and any of demographic information and keywords for the advertisement, for comparing a user profile with the metadata, and for generating an ad list for each client based on a match between the user profile and the metadata; and
an ad server for determining the user's location, matching the user profile to a plurality of ads based on the metadata and the user's location, determining an urgency measure comprising an ad budget divided by a time remaining in an ad campaign for each matching ad, determining a price for each matching ad as a function of a buyer's bid, a publisher's bid, and the number of ads that are available for a particular slot, determining a pace for each matching ad as a function of the number of ads remaining in the ad campaign divided by the time remaining for each ad, and selecting an ad from the plurality of ads based on the urgency measure, the price, the and the pace, and transmitting the selected ad to the ad player.

12. The system of claim 11, wherein the ad player is embedded within a webpage.

13. The system of claim 11, wherein the client comprises a mobile device.

14. The system of claim 11, wherein the application server generates reports from ad play statistics received from a plurality of clients.

15. The system of claim 13, wherein the mobile device transmits the user's location using a global positioning system.

16. The system of claim 15, wherein an ad list is generated according to the user's location as determined using the global positioning system.

17. The system of claim 11, wherein the advertisement comprises a coupon for a store.

18. The system of claim 11, wherein the geographic location is specified as the same zip code and a surrounding area of the user according to the user profile.

19. The system of claim 11, wherein the metadata further comprises restrictions on when to display the advertisements.

20. The system of claim 11, wherein the ad list is updated in response to the publishing server receiving an updated user profile.
